(19) United States
(12) Patent Application Publication
(10) Pub. No.: US 2024/0395522 A1
(43) Pub. Date: Nov. 28, 2024

(54) Systems and Methods for Background Ion Detection in Mass Spectrometry

(71) Applicant: DH Technologies Development Pte. Ltd., Singapore (SG)

(72) Inventors: Gordana IVOSEV, Entobicoke (CA); Chang LIU, Richmond Hill (CA); Stephen TATE, Barrie (CA); Hui ZHANG, Winchester, MA (US)

(21) Appl. No.: 18/693,311

(22) PCT Filed: Sep. 19, 2022
(86) PCT No.: PCT/IB2022/058849

§ 371 Date: Mar. 19, 2024

Related U.S. Application Data
(60) Provisional application No. 63/246,727, filed on Sep. 21, 2021.

(51) Int. Cl. H01J 49/00

(52) U.S. Cl. CPC H01J 49/0036; H01J 49/0031

(57) ABSTRACT

A method for performing mass spectrometry (MS) comprises receiving MS data corresponding to a plurality of MS runs, wherein MS data corresponding to an MS run of the plurality of MS runs comprises detected intensities for a plurality of mass over charge ratios (MZ values) during the MS run; finding a recurrent MZ value of the plurality of MZ values, wherein a detected intensity for the recurrent MZ value appears as a recurrent peak in MS data corresponding to a subset of the plurality of MS runs; and the subset of the plurality of MS runs includes at least two MS runs of the plurality of MS runs; and identifying the recurrent MZ value as corresponding to a background ion.

### TECHNICAL FIELD

The present disclosure in general relates to mass spectrometry and in particular to determining the background ions in mass spectrometry.

### BACKGROUND

The full-scan mode of mass spectrometry (MS) of different types, such as time of flight scan mass spectrometry (TOF scan MS) or various types using quadrupoles (such as Q1 scan MS), etc., has been widely used in various applications. The full scan mode of MS greatly simplifies the MS method development, and enables not only analysis of the target species, but also identification of other ions present in the sample. The full scan mode has been utilized routinely for untargeted profiling, reaction optimization, compound QC, etc.

Since the information extraction relies on the full scan mass spectra, it would be critical to differentiate the “signal ions” from the “background ions”. Such differentiation is especially critical for the workflows requiring the analysis of non-targeted mass over charge (m/z also called MZ hereinafter) values. Examples of such workflows include full spectra profiling for pattern matching (e.g., in cancer diagnosis via MasSpec Pen), purity assessment for the compound QC workflow, and by-product identifications for reaction optimizations.

Typically, there may exist more than one background ion or more than one type of background ion, each having multiple isotopes. These multiple ions and isotopes may define the background MZ-intensity pattern.

In some cases, such as in an Echo MS, there may exist two types of background mass spectra corresponding to two types of background ions. These two types could cause either false positives or false negatives in the analysis results. In this disclosure these two types are called type 1 and type 2, or equivalently first type and second type, and explained below.

The first type of background mass spectra resulting from a first type of background ions, may be sample independent; their appearances may be constant and not dependent on the introduction of the sample into a mass spectrometer for mass analysis. This type of background ions may originate in the mobile phase (carrier solvent), ion source, or system contaminations. The first type of mass spectrum, therefore, may appear both in the non-sample period, during which no sample is being introduced into the mass spectrometer, and in the sample plug period, during which a sample is being introduced into the mass spectrometer. Compared to its level in the non-sample period, the level of the first type of background spectra during the sample plug period may be the same or different; the level may be different because during sample introduction this type of background spectra may be enhanced (e.g. due to the pH change of the sample plug) or suppressed (e.g., due to the ionization suppression from the sample matrix).

The second type of mass spectra, on the other hand, may be sample dependent. The corresponding second type of background ions may originate in the matrix of the sample solution (e.g. sample solvent peaks). This type of background would have a different intensity between the sample plug timing period vs the non-sample timing period. It may be relatively constant for the samples from the same resource/assays, but may be different from batch to batch (e.g. samples dissolved in different lots of the solvents).

Some existing methods attempt to identify and subtract background spectra from the sample spectra. These methods, however, have many shortcomings.

One existing method determines the mass spectra during the non-sample period as an estimate of the type 1 background spectra. This method, however, cannot determine the type 2 background spectra. Moreover, even in its determination of the type 1 background, it cannot compensate for the potential enhancement or suppression of the type 1 background during the sample plug timing period. Therefore, by subtracting the measured background spectra from the full spectra (i.e., spectra containing mass peaks corresponding to an analyte under analysis as well as background ions, if any), it may derive erroneous values for the sample spectra. In addition, because in some high-throughput analysis systems (e.g. Echo MS), sample signals in the time domain are close to each other, the spectra do not provide a stable non-sample period for extracting the background MS spectra with this method.

Another existing method measures mass spectra of a separate “blank” sample to estimate both type 1 and type 2 backgrounds. This method also suffers from several shortcomings. To begin with, it requires additional efforts and time for preparing and measuring the mass spectra of the blank sample. Moreover, it poses the challenge of creating the ideal blank samples for all workflows and assays. Further, similar to the other method, this method cannot compensate for the potential background scale variations among different samples, which, for example, may result from the interaction of the background ions with the sample.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 shows a block diagram of a spectrometer-analyzer system according to some embodiments.

FIG. 2 shows two plots of MS data, including a spectral plot 200 of a full scan MS data and a heat map 250 derived from a plurality of full scan MS data, according to some embodiments.

FIG. 3 includes a section of a spectral plot set 300 and a corresponding time domain spectrum set 350 for multiple MS runs in one embodiment.

FIG. 4 shows a flow chart for a method 400 for identifying background ions based on their recurrence according to some embodiments.

FIG. 5 shows a section of a spectral plot set 500 according to some embodiments.

FIG. 6 shows a flow chart 600 for an MLR method performed by an analyzer module according to some embodiments.

FIG. 7 shows a frequency plot 700 and the corresponding features that the analyzer module extracts from some MS run data according to some embodiments.

FIG. 8 shows an example of applying the above subtraction method to MS data for two MS runs according to an embodiment.

FIG. 9A shows a spectrum intensity heat map 900 for a plurality of MS runs according to an embodiment.

FIG. 9B shows an MLR weight heat map 950 for the same plurality of MS runs as in FIG. 9A.

FIG. 10 schematically depicts an example of an implementation of a module according to some embodiments.

### DETAILED DESCRIPTION

Some embodiments provide methods and systems for detecting quantitative spectra of background ions or separating those spectra. Further, some embodiments utilize the detection of the background spectra for quantitative detection of compounds of interest. Some embodiments perform these operations in an unsupervised automated manner. Moreover, some embodiments also provide methods and mechanisms for measuring uncertainty in the analysis.

Moreover, various embodiments are able to determine the scale of the background ions, therefore enabling an accurate subtraction of the background spectra from the full spectra for determining the sample spectra in an accurate manner.

Various embodiments are able to extract both type 1 and type 2 background spectra and further derive the correct scale for the background spectra to be subtracted from the sample spectra.

Moreover, various embodiments are able to determine the background ions and their intensity scales for different types of ions and in different types of MS. For example, in liquid chromatography (LC) mass spectrometry, different background ions, and sometimes all of them, may have the same pattern across multiple cycles. In Echo MS (in which ultrasound energy is utilized to eject a sample into an open port of a mass analyzer), on the other hand, different or sometimes all of background ions, may have the same pattern across multiple wells. Hereinafter cycles or wells will be called sampling events. In some embodiments, a sampling event may also be called a mass spectrometry run, or an MS run for short.

The ions of interest, on the other hand, may be different or may have different MZ intensity patterns across different sampling events.

In some embodiments, background ion patterns may change in unknown ways across sampling events. In some embodiments, nevertheless, the background ions may preserve their MZ intensity patterns. Therefore, in some embodiments, some or all of background ions have the same intensity ratios between two sampling events.

Moreover, in some embodiments, ions of interest may appear in a subset of sampling events.

Some embodiments utilize one or more of the following steps in determining estimates of the background spectra. Some embodiments utilize most likely ratio (MLR) method across two sampling events. Further, some embodiments may extract different features from the MLR features as estimates for existence and intensities of background ions. These estimates may not depend on the type of the background ion. Further, the extracted features may provide estimates of the spectral intensity scaling factors for each sampling event. In some embodiments, a scaling factor for a sampling event may be a ratio of the intensity of a background spectrum for that sampling event to that intensity for a reference sampling event.

Some embodiments enable quantitative detection of background intensity and deconvolution of the detected background spectrum from spectrum of a compound of interest, even when the peaks for the two spectra overlap completely or partially, and therefore the background in the spectrum changes the shape or the intensity of the peak for the sample of interest.

Some embodiments provide a qualitative analysis of the compounds of interest by subtracting scaled representative background spectra from sampling event spectra to detect ions of interest.

Some embodiments provide a quantitative analysis by determining a contribution of a background ion to a peak of an ion of interest.

Some embodiments create a spectral library by subtracting background spectra from drive to spectra before adding the spectrum to the spectral library. Some embodiments further include in the spectral library derived information about the background spectrum.

Some embodiments enable searching the spectrum library by using a background subtracted spectrum for library matching.

Some embodiments utilize the derived compound related peaks to determine time dependent values of compound purity, degradation, fragmentation, or adduction.

Some embodiments utilize the derived data to estimate a spectral quality by, for example, comparing intensities of ions of interest against background ions or comparing spectra between two libraries for the workflows such as compound QC. Some embodiments perform compound QC workflow, but comparing the background subtracted mass spectra against some reference spectra, or by comparing across two sets of spectra from two libraries.

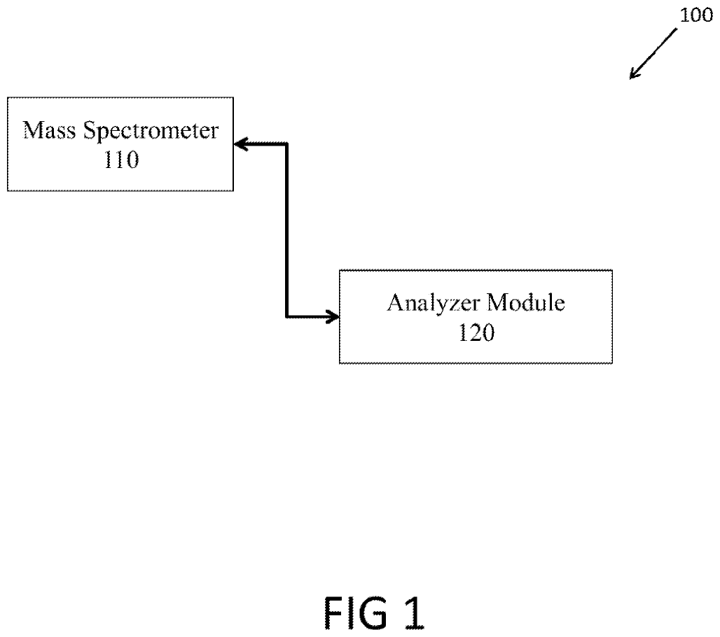

Some embodiments utilize a spectrometer-analyzer system (hereinafter called SA system) for performing the above techniques. FIG. 1 shows a block diagram of an SA system 100 according to some embodiments. System 100 includes a mass spectrometer 110 and an analyzer module 120. Hereinafter mass spectrometer may also be abbreviated to MS, to be distinguished from MS abbreviating spectrometry based on usage.

Spectrometer 110 may be any type of spectrometer capable of performing a full scan mode MS (hereinafter sometimes alternatively called full scan MS run or MS run for brevity). Spectrometer 110 may, for example, be a TOF span MS, a quadruple based MS, etc. Moreover, spectrometer 110 may utilize different mechanisms of sample introduction such as liquid chromatography (LC), sound pulses (as used in echo MS), etc.

Analyzer module 120 may be a module that analyzes MS data and accordingly determines background spectra or sample spectra as further described below. More specifically, analyzer module 120 may receive from spectrometer 110 data corresponding to one or more full scan mode MS and analyze those data to determine location or intensity of background spectra. Further, analyzer module 120 may subtract from the full scan MS data the derived background spectra to determine the presence, location, or intensity of sample data. In some embodiments, analyzer module 120 may send back to spectrometer 110 data corresponding to the derived background spectra. Spectrometer 110 may utilize these background spectra in its subsequent MS runs to, for example, exclude one or more of the background ion from the MS scan.

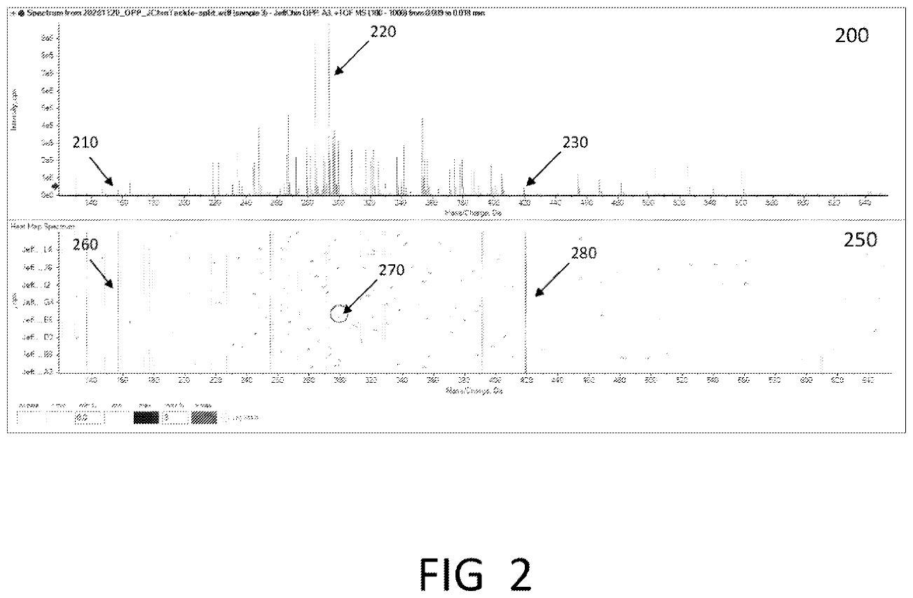

FIG. 2 illustrates some differences between the spectra of target ions and background ions. In particular, FIG. 2 shows two plots of MS data according to some embodiments. More specifically, the top plot is a spectral plot 200 of a full scan MS data according to some embodiment. The bottom plot, on the other hand, is a heat map 250 derived from a plurality of full scan MS data as further explained below. The plurality of full scan MS may include the MS corresponding to plot 200.

Spectral plot 200 illustrates intensities of mass spectra for a plurality of ions observed in a full scan MS run. More specifically, the X axis in this plot shows the values of MZ for ions in units of Dalton. The Y axis, on the other hand, shows the intensity of the spectra observed for each value of MZ, the intensity being in units of counts per second (cps). As seen in plot 200, the corresponding full scan MS has detected spectra for many ions in the form of many peaks of different intensities. In plot 200, three of those peaks have been labeled Peaks 210, 220, and 230, for further discussion. These peaks indicate existence of three ions. Peak 210 corresponds to an ion with an MZ value around 160 Daltons and an intensity less than 0.5×10\hat{ }5 cps. Similarly, peaks 220 and 230, correspond to ions with MZ values around 300 and 420 Daltons respectively, and intensities around 0.5×10\hat{ }5 and 0.5×10\hat{ }5 cps, respectively.

Heat map 250, indicates ions detected in the plurality of full scan MS and their intensities. More specifically, the abscissa shows the MZ values for the detected ions. The ordinate, on the other hand, lists the plurality of full scan MS by some discrete variable, such as an identification for each scan. For each ion detected in an MS run, the heat map includes the dot at the corresponding MZ value on the X axis and the corresponding run on the Y axis. For the ions that were detected in many runs, the corresponding dots are connected to form a vertical line. Therefore, lines 260 and 280, for example, indicate that the ions corresponding to peaks 210 and 230 have been detected in many MS runs. The ion corresponding to the high intensity peak 220, on the other hand, has appeared in at most a few runs such as the one circled and labeled 270.

In some embodiments, recurring appearance of an ion, such as those corresponding to peaks 210 and 230, may indicate that they correspond to a background ion that is common among different MS runs. Ions such as the one corresponding to peak 220, on the other hand, which may appear with high intensities but not recurringly, may correspond to sample-specific ions. A sample-specific ion, may be a target ion or a sample-specific impurity.

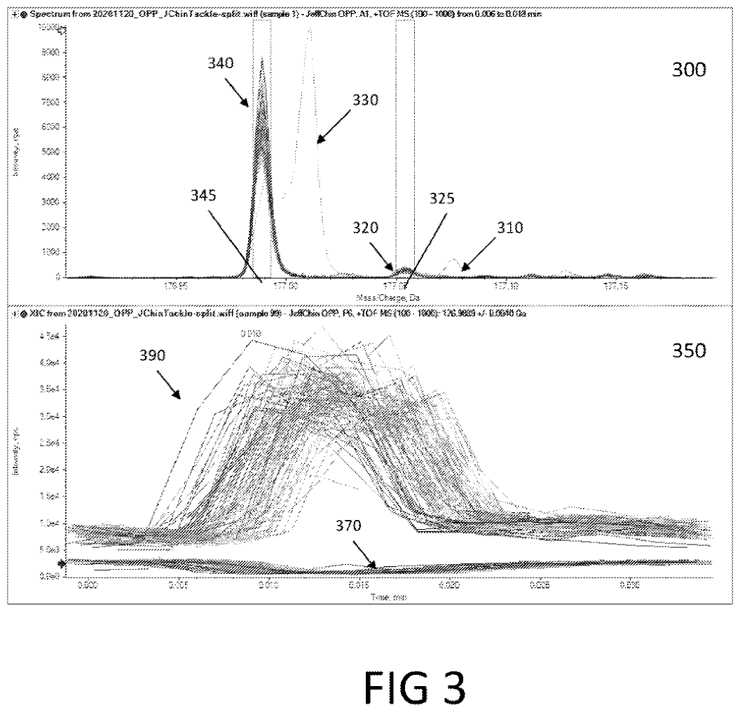

FIG. 3 further illustrates some characteristics of different types of background ions according to some embodiments. More specifically, FIG. 3 includes a section of a spectral plot set 300 and a corresponding time domain spectrum set 350 for multiple MS runs in one embodiment as further explained below.

Spectral plot set 300 includes multiple spectral plots, each of which illustrates MS data for one MS run in a manner similar to that of plot 200. To observe some details that are necessary for the following description, in plot set 300 the spectral plots have been magnified along the X axis by limiting the range of MZ values. As a result, FIG. 3 shows a section of spectral plot set 300 in an interval between around 176.90 and 177.20 Daltons.

In spectral plot set 300, some peaks recurringly appear around the same MZ value for multiple runs. More specifically, for a first set of MS runs, a recurrent peak appears at the MZ value marked as MZ value 325 (slightly more than 177.05). This first set of recurrent peaks have been collectively labeled peak set 320. Similarly, for a second set of MS runs, a recurrent peak appears at the MZ value marked as MZ value 345 (slightly less than 177.00 Daltons). The second set of recurrent peaks have been collectively labeled peak set 340. The MZ value of a recurrent peak, such as each of MZ values 325 and 345, is called a recurrent MZ value.

Some other peaks in spectral plot set 300 appear only in one of the multiple runs. Such peaks include those labeled 310 and 330. As also explained in relation to FIG. 2, each non-recurrent peak such as peak 310 or peak 330, and its MZ value, may correspond to a sample-specific ion, such as a target ion or a sample-specific impurity. Different non-recurrent peaks may appear in the same MS run or in different MS runs (as is the case in plot set 300). For future reference, the MS runs that include peaks 310 and 330 will be called 3rd and 4th MS runs.

Generally the first and the second set of MS runs may be the same set, or may be different sets with some overlap or no overlap. In the case of plot set 300, for example, the first and the second set of MS runs are the same set (hereinafter alternatively called the set of overlapping MS runs). As explained before in relation to FIG. 2, each of recurrent MZ values 325 and 345, may correspond to a background ion, in this case respectively called 1st and 2nd background ions or recurrent ions, for reference.

The intensity pattern in different MS runs may be the same or may be different. In plot set 300, for example, different MS runs in the set of overlapping MS runs, each of which include peak sets 320 and 340, have similar patterns. In such cases, the MS runs are considered to have high similarity with each other. The 3rd and the 4th MS runs, on the other hand, show patterns that are different from the MS runs in the set of overlapping MS runs. In particular, the 3rd and the 4th MS runs respectively include intensity peaks 310 and 330, which do not exist in the set of overlapping MS runs. In such cases, the third MS run or the 4th MS run are considered to have low similarity with, the MS runs in the set of overlapping MS runs. In some embodiments, as detailed below, the analyzer module derives a similarity factor, which is a quantitative measurement of similarity between two MS runs, and utilizes this factor to further analyze the spectrum.

Moreover, different peaks in a peak set may or may not overlap. In particular, as seen in peak sets 320 and 340, different peaks in a peak set may have different maximums. Moreover, when two MS runs are similar, the ratio of the intensities of the peaks in the two MS runs may be constant among different recurring MZ values. That is, the intensities of recurrent peaks in one of the MS runs may be approximately equal to the intensities of the corresponding recurrent peaks in the other MS run multiplied by a common factor. This common factor may be called a scaling factor between those two MS runs. In some embodiments, as further detailed below, the analyzer module derives a quantitative value for the scaling factor, and utilizes the scaling factor to further analyze the spectrum.

While the peak sets 320 and 340 both include recurrent peaks, they show different characteristics. These differences are illustrated in the time domain spectrum set 350, as further described below.

Time domain spectrum set 350 shows the time dependence of spectral intensities for recurrent MZ values 325 and 345, according to some embodiments. More specifically, for each MS run of the first set of MS runs, the intensity of the corresponding run spectrum for MZ value 325 as a function of time appears as one of the plots in the set of plots marked as plot set 370. Similarly, for each MS run of the second set of MS runs, the intensity of the corresponding run spectrum for MZ value 345 as a function of time appears as one of the plots in the set of plots marked as plot set 390. Moreover, for all plots, the time window covers the time periods of the sample plug passing through the MS for detection.

Plot set 370 shows that for each MS run in the first set, the intensity starts at an initial intensity around 0.25×10∝cps, and its value stays substantially the same throughout and after the sample introduction.

Plot set 390, on the other hand, shows that for each MS run in the second set, the intensity starts at an initial intensity around 1×10\hat{ }4 cps, increases to a maximum intensity of about 3×10∝cps around the time 0.015 minutes, and then decreases and plateaus to a final intensity near the initial intensity.

The differences in the time dependence of the intensities for the two recurrent MZ values 325 and 345 may indicate some characteristic differences in their origins.

More specifically, the relatively steady appearance of the recurrent first ion corresponding to MZ value 325, as seen in plot set 370, indicates that the first recurrent ion case exists throughout the MS run, irrespective of whether or not the sample is introduced. The first recurrent ion, therefore, may be a background Ion of the first type.

For recurrent MZ value 345, on the other hand, the spectrum intensity peaks around the time 0.015 minutes, as compared to the earlier times (near times 0.000 minutes) or the times after completion of the sample detection (around the time 0.030 minutes). This behavior indicates that the second recurrent ion is essentially generated by the introduction of the sample. The second background ion, therefore, may be a background ion of the second type.

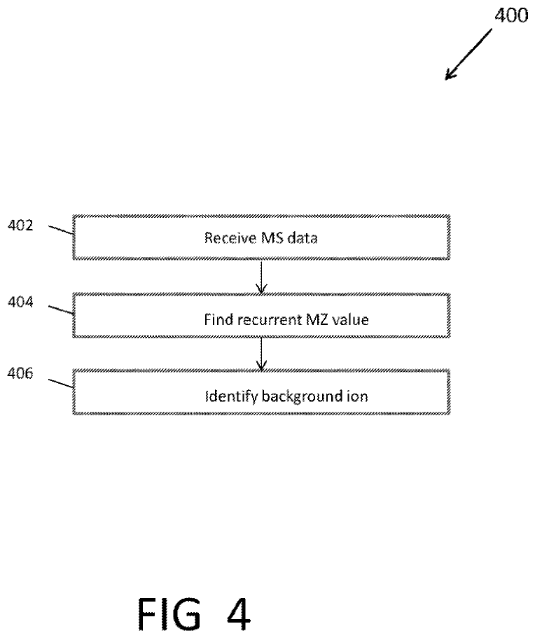

Some embodiments use the above described properties of background ions as recurrent ions to identify the background ions. FIG. 4 shows a flow chart for a method 400 for identifying background ions based on their recurrence according to some embodiments. In some embodiments, method 400 is performed by an analyzer module.

At step 402, the analyzer module receives MS data for a set of MS runs that includes multiple MS runs. One example of such MS data is plotted in spectral plot set 300.

At step 404, the analyzer module finds a recurrent MZ value. The recurrent MZ value may correspond to a set of recurrent peaks, such as recurrent peak sets 320 or 340 in plot set 300 of FIG. 3. In some embodiments, a recurrent peak may be a peak that appears in a subset of the MS runs. In some embodiments, this subset may consist of two or more members of the set of MS runs. Alternatively, in some embodiments, this subset may include a majority of the members of the set of MS runs. Various embodiments may use different techniques for finding a recurrent peak set. Those techniques may include a clustering analysis, an unsupervised multivariate analysis, a supervised multivariate analysis, a pattern recognition analysis, or a statistical analysis. In some embodiments, for example, a recurrent MZ value may be detected by applying k-mean clustering, PCA analysis (as an unsupervised method), or a pattern recognition analysis (usually a supervised method). A used technique may divide the MZ values to groups of similarly behaving MZ values across some dimensions. The considered dimensions may include sampling time during the plug introduction, sample run, or both. Statistical analysis of intensities across mentioned dimensions may be used to extract features for clustering/pattern recognition or other statistical tests. The extracted features may include minimum, maximum, standard deviation, etc. The technique may further include some normalization step to remove analytical intensity bias.

At step 406 of method 400, the analyzer module identifies one or more of the recurrent MZ values as corresponding to a recurrent background ion.

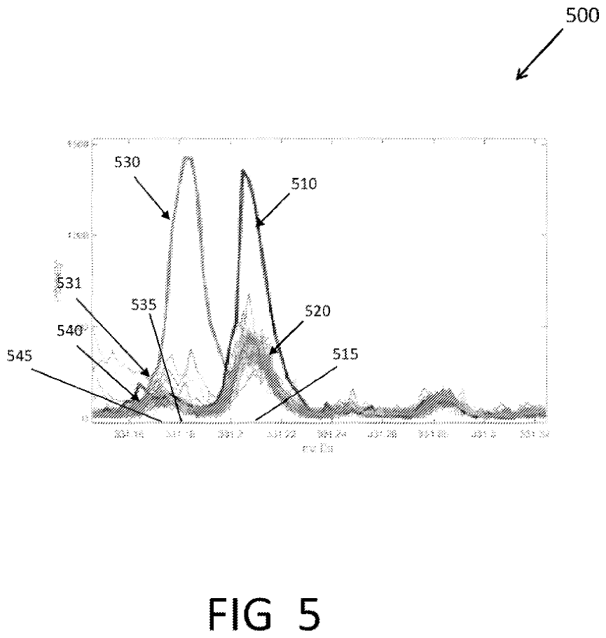

Some embodiments, in addition to identifying the background spectra, may require determining some quantitative characteristics of the background spectra in order to derive the spectra of the target ions accurately. In some cases, this requirement arises because the background spectra overlap or interfere with the target ion spectra. FIG. 5 illustrates one such case according to an embodiment.

FIG. 5 shows a section of a spectral plot set 500 in a manner similar to the spectral plot set 300 according to some embodiments. In particular, spectral plot set 500 includes two non-recurrent peaks 510 and 530 (hereinafter respectively called first and second non-recurrent peaks for future reference), which appear in two different MS runs (called first and second MS runs for future reference). The two non-recurrent peaks 510 and 530 may correspond to two different target ions (hereinafter respectively called first and second target ions) detected in the first and second MS runs, respectively.

Moreover, spectral plot set 500 includes two recurrent peak sets 520 and 540 (hereinafter respectively called 1st and 2nd recurrent peaks), corresponding to two sets of MS runs (called first and second sets of MS runs respectively). As explained before, the first and second recurrent peaks may correspond to two different background ions (respectively called first and second background ions). The first and second sets of MS runs, each include almost all of the MS runs plotted in plot set 500.

As seen in FIG. 5 and further explained below, the background spectra corresponding to peak sets 520 and 540 may interfere with the target ion spectra corresponding to peaks 510 and 530, respectively. The interference may occur when the MZ value for a background ion is the same or, more generally, close to the MZ value for a target ion.

For example, in spectral plot set 500, the MZ values for peak 510 and peak set 520 (that is, the MZ values for the first target ion and the first background ion) are equal 2, or very close to, MZ value 515 (around 331.21 Daltons). In this case, the analyzer module may determine that the first MS run also has detected the first background ion, but the spectrum for the first background ion has been included in the spectrum for the first target ion. That is, for the first MS run, a peak corresponding to the first peak set (peak set 520) has been included in the first peak (peak 510). This inclusion may have, for example, increased the intensity of the maximum or the total area under peak 510. Therefore, the spectrum intensity derived from peak 510 may not accurately represent the spectrum intensity for the first target ion.

To address this inaccuracy in peak 510, the analyzer module may further compute a scaling factor for the first background ion as further described below. The analyzer module may utilize the scaling factor for the first background ion to determine the intensity of the first background ion in the first MS run, and subtract that background intensity from the first peak to derive a measure of the spectral intensity for the first target ion that is more accurate than the intensity derived from first peak 510.

Similarly, in spectral plot set 500, the MZ value for peak set 540 (that is, MZ value 545 corresponding to the second background ion) is close to the MZ value for peak 530 (that is, MZ value 535 corresponding to the second target ion). More specifically MZ value 535 is about 331.18 Daltons and MZ value 545 is slightly below MZ value 535, about 331.17, which is close to MZ value 535. In some embodiments, a first MZ value is considered to be close to an MZ value for a peak, if the first MZ value is inside the domain of the peak. In some embodiments, the domain of a peak is a range of MZ value in which the plot corresponding to the peak has significant intensity values. In some embodiments, a significant intensity value is a fraction of the maximum value at the peak. In various embodiments the fraction may be ½, ⅕, 1/10, etc. In some embodiments, a significant intensity value is a value that is above a threshold intensity value. In various embodiments, the threshold intensity value may be 100 cps, 500 cps, 1000 cps, etc.

Because the MZ value for the second background ion (MZ value 545) is close to the MZ value for the second target ion (MZ value 535), the analyzer module may determine that the second MS run has detected the second background ion, but the spectrum for the second background ion has been included in the spectrum for the second target ion. That is, for the second MS run, a peak corresponding to the second peak set (peak set 540) has been included in the second peak (peak 530). This inclusion may have caused the small bump 531 in peak 530 or may have increased the total area under peak 530. Therefore, the spectrum intensity derived from peak 530 may not accurately determine the spectrum intensity for the second target ion.

To address this inaccuracy in peak 530, the analyzer module may further find a scaling factor for the second background ion as further described below. The analyzer module may utilize the scaling factor for the second background ion to determine the intensity of the second background ion in the second MS run, and stop tracked that background intensity from the second peak to derive and measure of this spectrum intensity for the second background ion that is more accurate than the intensity derived from second peak 530.

In some embodiments, the analyzer module, in addition to identifying MZ values for one or more background ions, derives some quantitative characteristics of a background ion spectrum, such as the scanning factor mentioned above. Some embodiments use a most likely ratio (MLR) method for identifying the background ions or some of their quantitative characteristics.

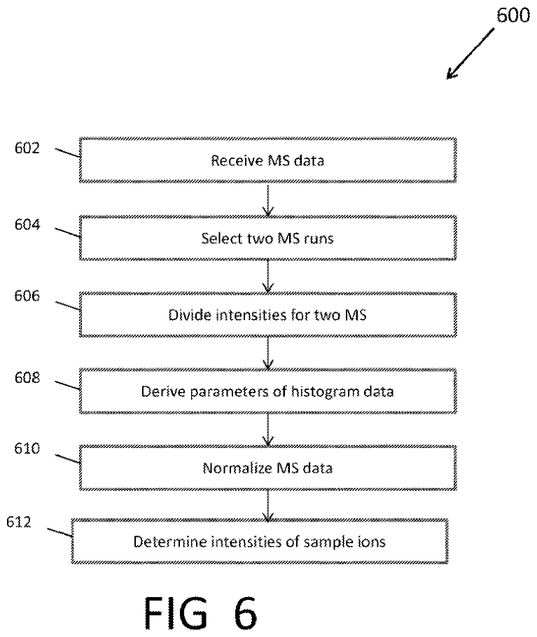

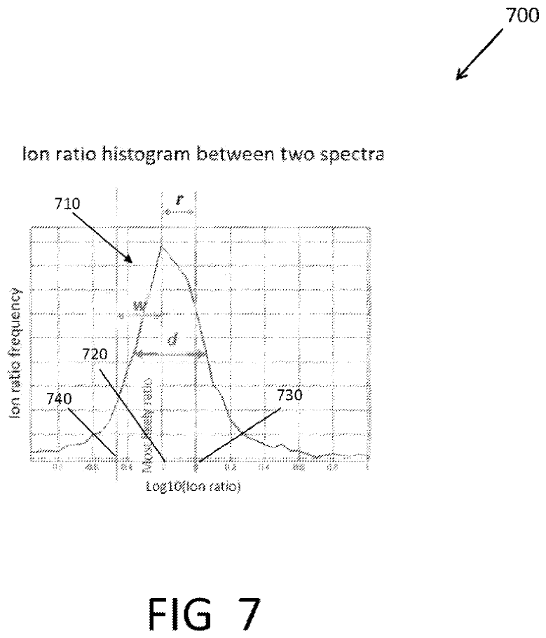

FIGS. 6 and 7 illustrate an example of applying the MLR method to some MS run data according to some embodiments. In particular, FIG. 6 shows a flow chart 600 for an MLR method performed by an analyzer module according to some embodiments. FIG. 7, on the other hand, shows a frequency plot 700 and the corresponding features that the analyzer module extracts from some MS RUN data. These figures. are further described below.

In flow chart 600, at step 602 the analyzer module receives MS data for a number of MS runs. Examples of such data were illustrated in FIG. 5.

At step 604, two of those MS runs are selected as a selected pair. In some embodiments, one of the MS runs is designated as a reference MS run. In these embodiments, the reference MS run may be always selected as one of the two MS runs in the selected pair, therefore the other selected MS runs are all compared to the reference MS run. For reference, the two MS runs will hereafter be referred to as first and second MS runs, and the two selected MS data will be referred to as the first MS data and the second MS data. The ordering of the two may be immaterial in the results, but for ease of reference, the first MS run may be considered to be the reference MS run.

At step 604, for each MZ value, the corresponding value of the intensity in the second MS dataset is divided by the corresponding value of the intensity in the first MS dataset to derive a ratio value for that MZ. The set of derived ratio values for MZ values are saved in a ratio dataset. Each entry in the ratio dataset may map an MZ value to the ratio value corresponding to that MZ value.

In some embodiments, the range of MZ values is partitioned into a plurality of MZ bins and the ratio value is calculated for each bin. More specifically, in each dataset, the average intensity of the MZ values in that bin may be assigned as the intensity of that bin. Then, for each bin, its intensities in the two datasets may be divided to derive the ratio value for that bin. In this case, the ratio dataset may map each bin to its assigned ratio value. In different embodiments, the bins may have the same size or different sizes. In some embodiments, the size of a bin may be determined by partitioning the range of MZ values into a number of equal size bins, where the number may depend on the characteristics of the analyzer module, such as its memory capacity or processor speed. In various embodiments, the number may be an integer numbers such as 100, 500, 1000, etc. In some embodiments, the size of a bin may be selected to be equal to a desired resolution, such as 0.1, 0.01, 0.001, etc. In some embodiments, the size of a bin may vary and for example, depend on the intensity of the MZ values in that bin averaged over those MZ values and over MS runs. For example, for MZ values located within the range of a peak, the bins may be selected to be smaller compared to the MZ values not located within such a range, therefore providing a higher resolution in those ranges compared to elsewhere.

At step 606, the frequencies of different ratio values in the ratio dataset is determined. In some embodiments, to determine the frequencies, the range of ratio values in the ratio dataset is partitioned into a number of ratio bins. Then, the number of ratio values that fall into each bin is counted and saved as the frequency for that bin. In some embodiments, the ratio values are saved or partitioned into bins in a logarithmic scale as further discussed below in relation to frequency plot 700.

The set of values of bins and corresponding frequencies are saved in a frequency dataset. More specifically, the frequency data set may map the value of each bin to the frequency of that value in the ratio data set. Moreover, the frequency data set may also include mappings from the value of each bin to the MZ values for which the ratio value falls into that bin.

In some embodiments, the ratio bins may have the same size determined based on a desired resolution or some characteristics of the analyzer module. Alternatively and in some other embodiments, the ratio bins may not have the same sizes. Instead, the size of a ratio bin may depend, for example, on the value of the ratio or its location with respect to the location of a peak in the frequencies. For example, if the frequency of the ratio values has a maximum at or near the ratio value 0 in the logarithmic scale (see frequency plot 700 as an example), then the ratio values near 0 may be partitioned into smaller bin sizes as compared to the ratio values farther from 0.

Frequency plot 700 shows a frequency graph 710 of a frequency dataset according to some embodiments. More specifically, in plot 700, the abscissa corresponds to base 10 logarithm of the ratio values and the ordinate corresponds to the frequencies. In this embodiment, frequency graph 710 is similar to a normal curve with a maximum at ratio value 720 (in this case −0.2 in the logarithmic scale) indicating that for the two selected MS runs, the most frequent ratio value has been 10\hat{ }(−0.2), which is approximately 0.63. This most frequent ratio value is also called the most likely ratio (MLR). The ratio value marked 730, has the zero value (in the logarithmic scale corresponding to a ratio value 1). This ratio value, therefore, corresponds to MZ values for which the intensities in the two MS runs were the same. Ratio value 730 is near the peak, or alternatively within the range of the peak, of frequency graph 710. This may be considered as an indication that the intensities in the two MS runs were close to each other.

At step 608, some features of the frequency dataset (hereinafter called MLR features) are determined.

One of the MLR features derived from the frequency data set may be the MLR scaling factor (hereinafter also called scaling factor). The scaling factor may be defined as the value of the MLR. In the illustrative example of graph 710, the scaling factor is shown and marked as r. Because, as mentioned above, in this example the MLR is approximately −0.2, the scaling factor would be −0.2 in logarithmic scale or r=10^{-0.20}˜0.630 in linear scale.

In some embodiments, the scaling factor indicates an approximate ratio of the intensities of the peaks in the two MS runs. In some embodiments, the scaling factor also determines the analytical bias measure. For example, in the illustrative example of graph 710, the above derived value of r may indicate that the peaks that are recurring between the first and the second MS runs, appear in the second MS run with intensities that are lower by a factor of 0.630. That is, to find the intensity of recurring ion in the second MS run, one can multiply the intensity of this same recurring ion in the first (reference) MS run by a factor of 0.630.

In some embodiments, the general characteristics of ratio frequencies with respect to the MLR provide some further information about the background ions or the target ions as further described below. An illustrative case would be the case of fully similar MS runs, defined as two MS runs in which the second MS run has exactly the same pattern as the first MS run or, in other words, the second MS run is a mere multiplication of the first MS run by a factor M. The factor M could have any positive value, with M<1 representing miniaturization, M=1 representing duplication and overlap; and M>1 representing magnification. For such a case of two fully similar MS runs, the frequency graph would be a delta function, that is, a function that is zero everywhere except at the ratio value of MLR=log M, at which it has a frequency equal to the total number of MZ values bins.

Noteworthy is that in the case of two fully similar MS runs, multiplying the intensities in the MS data of the second MS run by the scaling factor causes it to fully overlap and become identical to the MS data of the first MS run.

In other cases, in which the two MS runs are not fully similar and have patterns that are not exactly identical in the manner explained above, the frequency graph deviates from being a delta function. Some of those deviations define other MLR features used for analyzing the spectrum as further explained below.

For example, another MLR feature that may be derived from the frequency data set is an MLR weight (hereinafter also called weight) assigned to some or all of the ratio values and the corresponding MZ. In particular, the weight assigned to a ratio value is the inverse of the distance between its frequency and the frequency of the MLR. In some embodiments, the value of the MLR weight is inversely proportional to reproducibility of each measurement.

As an illustrative example, in graph 710 of FIG. 7, a ratio value 740 and the inverse of its corresponding weight w have been marked. More specifically, ratio value 740, which has been selected arbitrarily, has an approximate value of −0.48 (in the logarithmic scale). The corresponding weight for ratio value 740 is the inverse of the distance w between ratio value 740 and the MLR (which in this case, as explained above, is approximately −0.2 in the logarithmic scale). Therefore, for ratio value 740, the weight w is calculated to be weight=1/w= 1/10^{-0.20-(-0.48)}=10^{-0.28}˜0.525. In some embodiments, the weight is further normalized by, for example, divining it to the sum of all weights for all MZ values. Moreover, this weight is assigned to those MZ values in the second MS dataset for which the ratio value was ratio value 740. Those MZ values can be determined by the mapping between the ratio values and the MZ values saved in the frequency data set.

In some embodiments, a lower weight indicates a higher reproducibility. For example, for two fully similar MS runs, as discussed above the frequency graph would be a delta function and for all MZ values w would be 0, indicating that all MZ values have the same very large value for weight. In other cases, for some MZ values w would be non-zero. Smaller values of w (which means larger weights) indicate that the corresponding MZ values belong to MZ value ranges in which the two MS runs have similar patterns. Therefore, ions that are detected in these ranges are more likely to be recurrent ions, and possibly background ions. Conversely, larger values of w (which means smaller weights) indicate that the corresponding MZ values belong to MZ value ranges in which the two MS runs have different patterns. Therefore, ions that are detected in these ranges are more likely to be non-recurring ions, and possibly target ions.

Another MLR feature derived from the frequency data set may be the MLR width (hereinafter also called width), which is defined as the width of the frequency plot. In the illustrative example of graph 710, this feature is marked as d. In some embodiments the width is defined as the distance between the half maximum locations on the two sides of the maximum. The half maximum locations are the locations at which the value of the frequency reaches half of its maximum value at the peak.

In some embodiments, the width provides a measurement of similarity between the two MS runs and, injection reproducibility. For example, in the above case of two fully similar MS runs, as discussed above the frequency graph would be a delta function which has zero width. The zero width indicates that the two MS runs are completely similar, as expected. A non-zero width, on the other hand, shows that the two MS runs are not completely similar, and larger width indicates higher dissimilarity.

Returning to flowchart 600 in FIG. 6, at step 610, the analyzer module uses the derived MLR features to normalize the MS data for different MS runs.

To that end, in some embodiments, the analyzer module may select a reference MS run. The analyzer module may select the MS run randomly or by finding an MS run that indicates a higher similarity to a larger number of other MS runs. For example, in some embodiments, the analyzer module may find the frequency data set for multiple pairs of MS runs. In some embodiments those multiple pairs maybe all, or a subset of all, possible pairs of MS runs. For each pair, the analyzer module may determine the MLR width and assign that width as a pairwise similarity factor to each of the two MS runs in the pair. After completing this process for all of the multiple pairs, the analyzer module may find a total similarity factor for each MS run as the sum of all pairwise similarity factors assigned to that MS run and select the reference MS run as the MS run that has the lowest total similarity factor. Alternatively, the analyzer module may select a similarity threshold value and consider a pair of MS runs to be similar if there are pairwise similarity factor is lower than the threshold. Then, the analyzer module may select the reference MS run as the MS run for which the number of similar Ms is the largest or is larger than a number.

Further, the analyzer module may normalize MS runs based on the selected reference MS run. More specifically, the analyzer module may find the scaling factor for all other Ms fronts and normalize them by multiplying the intensities by the scaling factor. In doing so, the intensities of the recurring ions that are common between each MS run and the reference MS run will be normalized. For example, for the two MS runs corresponding to graph 710 of FIG. 7, the intensity of a recurring ion may be selected from the reference MS run and multiplied by r=0.630 to determine the intensity of the same recurrent ion in the second MS run.

Returning to flowchart 600 in FIG. 6, at step 612, the analyzer module may then determine intensities of sample ions by subtracting the resulting intensities of the background ions from the second MS run to remove the intensities of the background ions from the second MS data. As further discussed below, this method can be used in cases that recurring ion is expected to exist in the second MS run but its intensity may be overlapped or overshadowed by the intensity of another ion, for example, a target ion. Therefore, the MS data after the subtraction reflects a more accurate spectrum of the target ions, as further illustrated below.

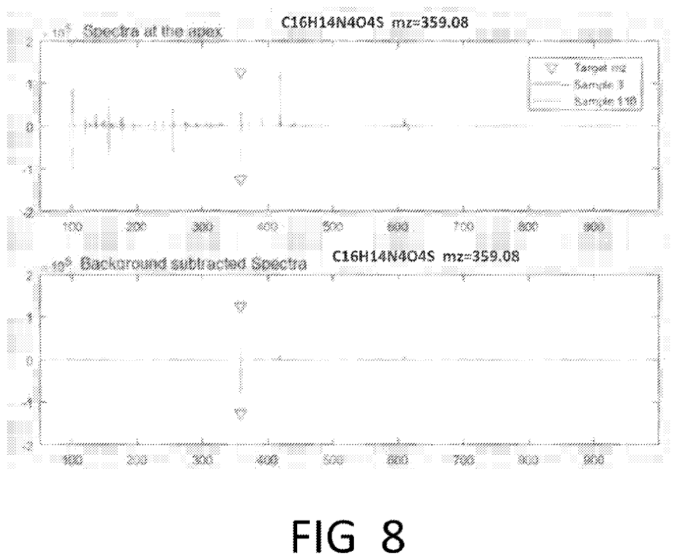

FIG. 8 shows an example of applying the above subtraction method to MS data for two MS runs according to an embodiment. More specifically, the top panel shows the raw MS data before subtraction, and the bottom panel to the MS data after the subtraction of the subtraction. Each panel shows the MS data for two samples containing the same compound. The positive data correspond to a ref compound library, and the inversed data correspond to the test library. In each panel, the triangle marks the expected MZ value for the target ion.

The bottom panel shows the background subtracted MS for these two samples, with the spectra significantly simplified.

More specifically, in the lower panel, the peaks corresponding to many background ions have been removed and the peak corresponding to the target ion (marked by the triangle) remains and can be identified.

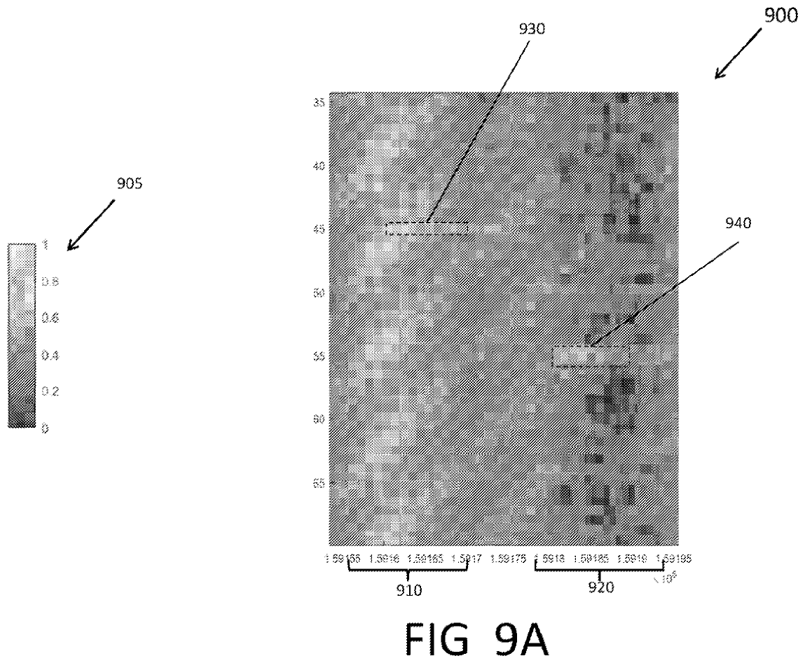

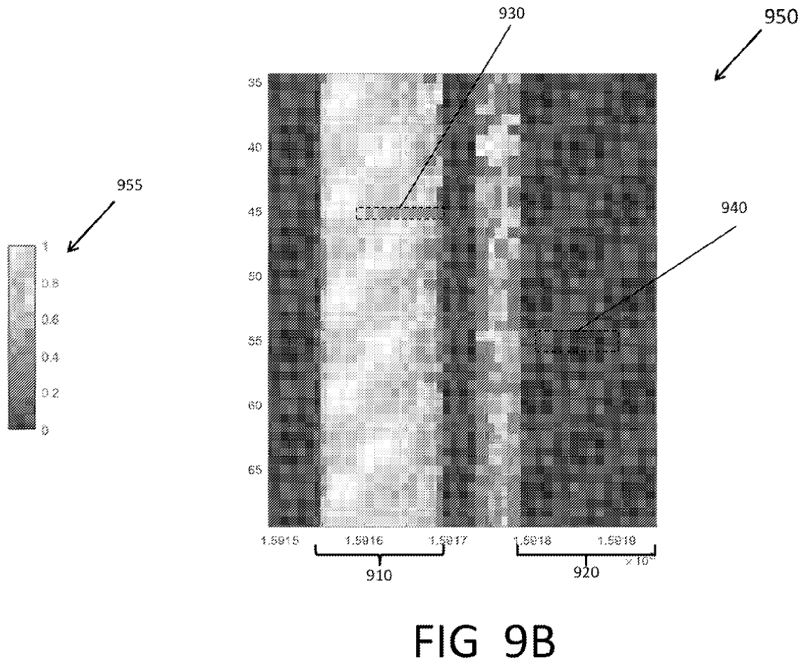

FIGS. 9A and 9B illustrate the process of identifying and subtracting background spectra according to some other embodiments. In particular, FIG. 9A shows a spectrum intensity heat map 900 (as further explained below) for a plurality of MS runs according to an embodiment. FIG. 9B, on the other hand, shows an MLR weight heat map 950 (also further explained below) for the same plurality of MS runs.

Intensity heat map 900 visualizes the spectrum intensities detected for a range of MZ values in the plurality of MS runs. In heat map 900, the MZ values have been indexed. More specifically, the abscissa shows the indexes of the MZ values in a range starting from around 1.59155×10\hat{ }5 to around 1.59195×10\hat{ }5. The ordinate, on the other hand, lists the plurality of MS runs by some arbitrary ordering number ranging from MS run number 35 to MS run number 70. In intensity heat map 900, a cell with coordinates (x,y) represents the intensity of the spectrum for the MZ value corresponding to the x coordinate, in the MS run corresponding to the y coordinate, and the intensity is shown by the hue of the cell based on the hue legend 905.

MLR weight heat map 950, on the other hand, visualizes the MLR weights in the plurality of MS runs using the same type and values for the abscissa and the ordinate. In MLR weight heat map 950, hue of a cell indicates the value of the MLR weight for the MZ value and MS run indicated by its x and y coordinates, respectively, in a manner similar to intensity heat map 900 and as referenced by legend 955.

In heat maps 900 and 950, some areas have been marked. In particular two vertical stripes are marked as stripes 910 and 920 using two ranges of MZ values. More specifically, at first stripe 910 corresponds to cells in a first range of MZ value indexes between around 1.59155×10\hat{ }5 and 1.59170×10\hat{ }5 for all MS runs. Similarly, a second stripe 920 corresponds to cells in a second range of MZ value indexes between around 1.59180×10\hat{ }5 and 1.59195×10\hat{ }5 for all MS runs. Further, first rectangle 930 corresponds to cells in a range of MZ value indexes between around 1.591575×10\hat{ }5 and 1.59170×10\hat{ }5 for MS run number 45. Similarly, second rectangle 940 corresponds to cells with MZ value indexes between around 1.59180×10\hat{ }5 and 1.591875×10\hat{ }5 for MS run numbers 54 and 55.

Studying the first stripe 910 in intensity heat map 900 indicates that in the first stripe, all cells have shown similar high intensities for all MS runs. Therefore, the first range of MZ values may correspond to recurrent ions.

Next, studying the first stripe 910 in MLR weight heat map 950 indicates that for the cells in the first stripe, the MLR weight has a high value for almost all cells except the cells in the rectangle 930. Therefore, the recurrent ions in the first range of MZ values would be candidates for background ions in all MS runs except for those corresponding to the first rectangle. The cells in the first rectangle, are instead candidates for target ions for which the MZ values overlap with MZ values of background ions.

Next, studying the second stripe 920 in intensity heat map 900, indicates that for the cells in the second stripe, all cells except for those in the second rectangle 940 show relatively low intensities. Therefore, the second range of values would not be candidates for background ions. Instead, the MZ values and MS runs corresponding to the second rectangle 940 may correspond to non-recurrent ions detected only in MS runs corresponding to the second rectangle. This conclusion may further be borne by the MLR weight heat map 950. This heat map indicates very low MLR weights for all cells in the second stripe, indicating that those cells are not candidates for background ions.

In some embodiments, the process of background determination and subtraction may also be carried out during the sample run on-the-fly. For example, the first several ejections of the plate could be used to identify the background MS spectra. This background subtraction could be carried out for the following IDA analysis, where the ions to be set for MS/MS is based on the subtracted TOF scan spectra.

### Conclusion and General Terminology

In various embodiments, one or more of disclosed modules may be implemented via one or more computer programs for performing the functionality of the corresponding modules, or via computer processors executing those programs. In some embodiments, one or more of the disclosed modules may be implemented via one or more hardware units executing firmware for performing the functionality of the corresponding modules. In various embodiments, one or more of the disclosed modules may include storage media for storing data used by the module, or software or firmware programs executed by the module. In various embodiments, one or more of the disclosed modules or disclosed storage media may be internal or external to the disclosed systems. In some embodiments, one or more of the disclosed modules or storage media may be implemented via a computing “cloud”, to which the disclosed system connects via a network connection and accordingly uses the external module or storage medium. In some embodiments, the disclosed storage media for storing information may include non-transitory computer-readable media, such as a CD-ROM, a computer storage, e.g., a hard disk, or a flash memory. Further, in various embodiments, one or more of the storage media may be non-transitory computer-readable media that store data or computer programs executed by various modules, or implement various techniques or flow charts disclosed herein.

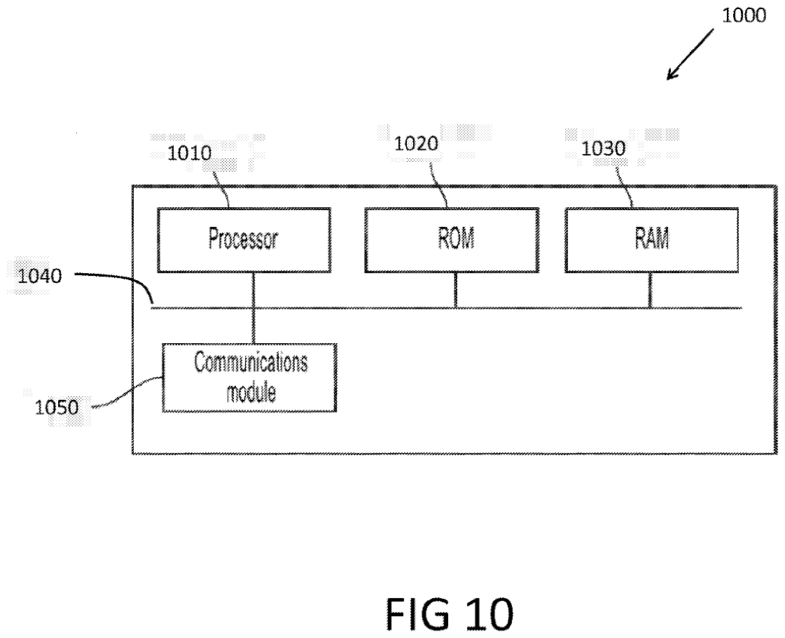

By way of example, FIG. 10 schematically depicts an example of an implementation of a module 1000 according to some embodiments. Module 1000 includes a processor 1010 (e.g., a microprocessor), at least one permanent memory module (e.g., ROM 1020), at least one transient memory module (e.g., RAM) 1030, a bus 1040, and a communication module 1050.

Processor 1010, ROM 1020, and RAM 1030 may be utilized to store and execute instructions performing the function of module 1000. Moreover, bus 1040 may allow communication between the processor and various other components of the controller.

Communication module 1050 may be configured to allow sending and receiving signals.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

The disclosed systems, methods, and apparatus are not limited to any specific aspect or feature or combinations thereof, nor do the disclosed systems, methods, and apparatus require that any one or more specific advantages be present, or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A method for performing mass spectrometry (MS), the method comprising:
receiving MS data corresponding to a plurality of MS runs, wherein MS data corresponding to an MS run of the plurality of MS runs comprises detected intensities for a plurality of mass over charge ratios (MZ values) during the MS run;
finding a recurrent MZ value of the plurality of MZ values, wherein:
a detected intensity for the recurrent MZ value appears as a recurrent peak in MS data corresponding to a subset of the plurality of MS runs; and
the subset of the plurality of MS runs includes at least two MS runs of the plurality of MS runs; and
identifying the recurrent MZ value as corresponding to a background ion.

2. The method of claim 1, wherein the subset of the plurality of MS runs includes a majority of the plurality of MS runs.

3. The method of claim 1, wherein the recurrent MZ value is a member of a subset of MZ values for which corresponding intensities exceed a threshold intensity.

4. The method of claim 1, wherein finding the recurrent MZ value includes performing at least one of a clustering analysis, an unsupervised multivariate analysis, a supervised multivariate analysis, a pattern recognition analysis, or a most likely intensity analysis.

5. The method of claim 1, wherein finding the recurrent MZ value includes finding MZ values for which corresponding intensities in the subset of the plurality of MS runs are comparable.

6. The method of claim 5, wherein finding the recurrent MZ value includes:
for a pair of MS runs of the plurality of MS runs, dividing the detected intensities to generate an intensity ratio dataset;
generating a frequency dataset corresponding to frequencies of values in the intensity ratio dataset; and
finding the recurrent MZ value as an MZ values for which corresponding frequency ratio is in a neighborhood of 1.

7. The method of claim 6, wherein finding the recurrent MZ value comprises:
performing a most likely ratio (MLR) analysis of the frequency dataset; and
extracting from the MLR analysis at least one MLR feature.

8. The method of claim 7, wherein the at least one MLR feature includes a scaling factor.

9. The method of claim 7, wherein the at least one MLR feature includes either one of a mass over charge reproducibility measure and a background reproducibility measure.

10. (canceled)

11. The method of claim 1, wherein the background ion includes either one of a sample dependent background ion and a sample independent background ion.

12. (canceled)

13. The method of claim 1, further comprising subtracting the background ion from the MS data to derive sample data.

14. The method of claim 1, wherein the plurality of MS runs utilize liquid chromatography for sample introduction.

15. The method of claim 1, wherein the plurality of MS runs utilize Echo MS for sample introduction.

16. The method of claim 1, wherein the plurality of MS runs utilize time of flight mass spectrometry.

17. The method of claim 1, wherein the plurality of MS runs include full scan MS.

18. The method of claim 1, further comprising:
identifying a section of the MS data as background data; and
determining a scaling factor corresponding to the background data.

19. The method of claim 18, further comprising utilizing the scaling factor for subtracting the background ion from the MS data to derive sample data.

20. The method of claim 13, further comprising including the sample data in a spectra reference library.

21. The method of claim 1, further comprising subtracting the background ion from subsequent MS runs on the fly.

22. A system for analyzing ions, the system comprising:
a mass spectrometer for receiving ions generated by an ion source;
an analyzer module operatively coupled to the mass spectrometer, the analyzer module comprising:
a processor; and
a memory including program code configured to, when executed, cause the processor to:
receive MS data corresponding to a plurality of MS runs, wherein MS data corresponding to an MS run of the plurality of MS runs comprises detected intensities for a plurality of mass over charge ratios (MZ values) during the MS run;
find a recurrent MZ value of the plurality of MZ values, wherein:
a detected intensity for the recurrent MZ value appears as a recurrent peak in MS data corresponding to a subset of the plurality of MS runs; and
the subset of the plurality of MS runs includes at least two MS runs of the plurality of MS runs; and
identify the recurrent MZ value as corresponding to a background ion.
